(19) United States
(12) Patent Application Publication
(10) Pub. No.: US 2026/0326061 A1
(43) Pub. Date: Oct. 22, 2026

(54) HEATING-AND-PRESSURIZATION INTEGRATED HIGH-TEMPERATURE AND HIGH-PRESSURE MICRO-REACTOR AND METHOD OF ITS OPERATION

(71) Applicant: SHENYANG UNIVERSITY OF CHEMICAL TECHNOLOGY, Liaoning (CN)

(72) Inventors: Guangwen XU, Liaoning (CN); Xuejing LIU, Liaoning (CN); Chong LI, Liaoning (CN); Yingpeng XIE, Liaoning (CN); Junrong YUE, Liaoning (CN); Xin JIA, Liaoning (CN); Ping AN, Liaoning (CN)

(73) Assignee: SHENYANG UNIVERSITY OF CHEMICAL TECHNOLOGY, Liaoning (CN)

(21) Appl. No.: 19/697,509

(22) Filed: Jun. 3, 2026

Related U.S. Application Data
(63) Continuation of application No. PCT/CN2024/134062, filed on Nov. 25, 2024.

(30) Foreign Application Priority Data
Dec. 4, 2023 (CN) 202311645746.3

(51) Int. Cl. B01J 8/18; B01J 8/24

(52) U.S. Cl. CPC B01J 8/1836; B01J 8/1818; B01J 8/1872; B01J 8/24; B01J 2208/00407; B01J 2208/00415; B01J 2208/00504; B01J 2208/00539; B01J 2208/00938

(57) ABSTRACT

The present application provides a heating-and-pressurization integrated high-temperature and high-pressure microreactor and a method of its operation, relating to a reactor and a process method thereof. The reactor includes a pressure-resistant outer cylinder, a pressure balance chamber, a high-temperature heating furnace, and a microreactor. The pressure balance chamber is a chamber formed between an inner wall of the pressure-resistant outer cylinder and outer walls of the high-temperature heating furnace and the microreactor. The high-temperature heating furnace and the microreactor are disposed inside the chamber. Each of the pressure balance chamber and the microreactor is connected to a carrier gas to maintain the pressure inside the microreactor and the pressure inside the pressure balance chamber. The present application enables simultaneous high temperature and pressure, reducing reactor material requirements and satisfying reaction tests at higher temperatures under high-pressure conditions.

### CROSS-REFERENCE TO RELATED APPLICATIONS

This application is a continuation of International Application No. PCT/CN2024/134062, filed on Nov. 25, 2024, which claims priority to Chinese Patent Application No. 202311645746.3, filed on Dec. 4, 2023. The disclosures of the aforementioned applications are hereby incorporated by reference in their entireties.

### BACKGROUND

### Technical Field

The present application relates to a reactor and a method of its operation, and particularly to a heating-and-pressurization integrated high-temperature and high-pressure microreactor, and a method of its operation.

### Description of Related Art

High-temperature and high-pressure reactors are important reaction devices in chemical engineering processes, and they embody significant value in multiple reactions such as gasification, catalysis, synthesis, and hydrogenation.

High-temperature, high-pressure, and rapid thermochemical reactions, such as high-temperature thermal cracking of fuels, high-temperature and high-pressure gasification, flash roasting of powder, and deflagration of energetic materials, widely occur in industrial fields such as chemical engineering, energy, environment, mineral processing, and aerospace. However, under pressurized conditions, the flow behavior, material structure, and properties of fluids change significantly, affecting momentum transfer, heat transfer, and mass transfer within the reactor, thereby leading to physical changes and chemical reaction behaviors during material conversion. This results in large deviations from the fluid characteristics, transfer laws, conversion behaviors, kinetics, and other related data measured under atmospheric-pressure conditions, as well as from empirical formulas derived based on such data. Furthermore, pressurized conditions impose higher challenges on reactor design, process development, instrument configuration, and safe operation.

According to pressure differences, differential reactors for thermochemical reaction testing can be divided into atmospheric and pressurized types. Typical representatives of the latter include: American CDS pyrolyzers, with a maximum operating pressure≤3.0 MPa (temperature ≤800 °C); micro fluidized bed/spouted bed reactors, with a maximum operating pressure≤5.0 MPa (temperature≤800 °C); settling furnace series converters, with an operating pressure≤3.0 MPa (temperature≤1400 °C at 1.5 MPa); and conventional fluidized bed reactors. Fan Y. M. et al. from Tsinghua University used a fluidized bed (inner diameter 30 mm) to study the characteristics of CaO-CO₂ absorption under a steam atmosphere at 3 MPa (1000 °C).

Currently, high-temperature and high-pressure reactors still commonly suffer from the problem of limited temperature elevation under high pressure. Particularly when the reaction produces hydrogen-rich product gas, the hydrogen embrittlement phenomenon of metal materials limits the tolerable reaction temperature.

### SUMMARY

An objective of the present application is to provide a heating-and-pressurization integrated high-temperature and high-pressure microreactor and a method of its operation. The present application adopts a micro pressurization chamber structure with pressure balance between the inside and outside of a reactor, where a high-temperature heating furnace and the microreactor are disposed inside the pressure balance chamber. Therefore, simultaneous pressurization of the inside and outside of the microreactor can be realized, a state of simultaneous high temperature and high pressure can be formed, the requirements on the reactor material and wall thickness in terms of the resistance to hydrogen embrittlement are reduced, and thus the reactor can satisfy reaction tests and applications at higher temperatures under high-pressure conditions.

The technical solution of the present application: the present application provides a heating-and-pressurization integrated high-temperature and high-pressure microreactor, including, from the outside to the inside in sequence, a pressure-resistant outer cylinder, a pressure balance chamber, a high-temperature heating furnace, and a microreactor.

The pressure-resistant outer cylinder is provided with a first pressurized gas inlet and a first pressurized gas outlet. The pressure balance chamber, the high-temperature heating furnace, and the microreactor are included inside the pressure-resistant outer cylinder.

The pressure balance chamber is a chamber formed between an inner wall of the pressure-resistant outer cylinder and outer walls of the high-temperature heating furnace and the microreactor, and the high-temperature heating furnace and the microreactor are disposed inside the chamber.

The high-temperature heating furnace is a high-temperature micro heating furnace or a heating wire, disposed between the outer wall of the microreactor and the pressure balance chamber.

The microreactor is arranged in the high-temperature heating furnace, and the outer wall of the reactor is connected to the pressure-resistant outer cylinder. Both a top and a bottom of the microreactor are sealed by a first sealing flange and a second sealing flange, respectively. A feed inlet connection pipe, a temperature measuring thermocouple connection pipe, and a second pressurized gas outlet are provided above the flange on the top of the microreactor. A second pressurized gas inlet is provided on the flange at the bottom of the microreactor. A distribution-plate-equipped reaction tube, a reaction tube support column, and a reaction tube support column lifting spring are arranged inside the microreactor from top to bottom in sequence. The distribution-plate-equipped reaction tube is arranged in a constant temperature zone. An expansion joint is provided at an upper portion of the microreactor to prevent expansion of the microreactor during heating. The bottom openings of the feed inlet connection pipe and the temperature measuring thermocouple connection pipe are positioned above a distributor plate.

In a possible embodiment, each of the first pressurized gas outlet and the second pressurized gas outlet is connected to a safety relief valve.

In a possible embodiment, the microreactor has a height of not more than 100 cm, and has an inner diameter of not more than 50 mm.

In a possible embodiment, the first pressurized gas inlet is connected to a carrier gas to maintain the pressure inside the pressure balance chamber.

In a possible embodiment, the second pressurized gas inlet is connected to a carrier gas to maintain the pressure inside the microreactor.

In a possible embodiment, the distribution-plate-equipped reaction tube can be made of a material selected according to reaction requirements, such as quartz material or corundum material.

In a possible embodiment, a gas product generated by a reaction is discharged through the second pressurized gas outlet.

The present application provides a operation method of a heating-and-pressurization integrated high-temperature and high-pressure microreactor, the process flow of which is as follows: firstly, fluidized particles (e.g., quartz sand) are preplaced into a distribution-plate-equipped reaction tube; a microreactor is assembled by means of sealing flanges; heating is performed to a preset temperature; then gas, such as nitrogen or air, is simultaneously introduced into a pressure balance chamber and the microreactor through a first pressurized gas inlet and a second pressurized gas inlet respectively according to set pressures to simultaneously pressurize the microreactor and the pressure balance chamber, thereby reaching a high-temperature and high-pressure state; then, a sample is injected through a feed inlet connection pipe into the distribution-plate-equipped reaction tube, and a gas product generated by a reaction is discharged through a second pressurized gas outlet.

Technical effects of the present application are as follows.

The present application adopts a micro pressurization chamber structure with pressure balance between the inside and outside of the reactor, where the high-temperature heating furnace and the microreactor are disposed inside the pressurizing chamber. Therefore, simultaneous pressurization of the inside and outside of the microreactor can be realized, a state of simultaneous high temperature and high pressure can be formed, the requirements on the reactor material and wall thickness in terms of the resistance to hydrogen embrittlement are reduced, and thus the reactor can satisfy reaction tests and applications at higher temperatures under high-pressure conditions.

The significant features are as follows.
1. The high-temperature heating furnace and the microreactor are disposed inside the pressure balance chamber, allowing simultaneous pressurization of the chamber and the microreactor, thus easily achieving a high-temperature and high-pressure state.
2. The material of the reaction tube can be selected according to the requirements of reaction systems, avoiding the influence of the material on reactions.
3. By adopting a micro pressurization chamber structure with pressure balance between the inside and outside of the reactor, the microreactor achieves simultaneous pressurization of the inside and outside thereof, eliminating the need to consider the tolerance of the reactor material to high temperature and high pressure, and significantly reducing the requirements on the reactor material and wall thickness in terms of the resistance to hydrogen embrittlement.
4. The high-temperature heating furnace is disposed inside the pressure balance chamber, and the pressurizing gas outside the reactor is almost in a static state, resulting in minimal heat loss, thus achieving rapid heating of particulate materials inside the reactor and rapid reaction initiation.

### BRIEF DESCRIPTION OF DRAWINGS

FIG. 1 is an external view of an integrated reactor provided in Example 1 of the present application.

FIG. 2 is a schematic top view of the integrated reactor provided in Example 1 of the present application.

FIG. 3 is a schematic A-A cross-sectional view of the integrated reactor provided in Example 1 of the present application.

FIG. 4 is a schematic B-B cross-sectional view of the integrated reactor provided in Example 1 of the present application.

Reference Numerals: 1—pressure-resistant outer cylinder; 2—pressure balance chamber; 3—high-temperature heating furnace; 4—microreactor; 5—first pressurized gas outlet; 6—first pressurized gas inlet; 7—second pressurized gas outlet; 8——second pressurized gas inlet; 9—first sealing flange; 10—second sealing flange; 11—temperature measuring thermocouple connection pipe; 12—feed inlet connection pipe; 13—expansion joint; 14—distribution-plate-equipped reaction tube; 141—distributor plate; 15—reaction tube support column; 16—reaction tube support column lifting spring.

### DESCRIPTION OF EMBODIMENTS

In order to make the objectives, technical solutions, and advantages of the present application clearer, the embodiments of the present application will be further described in detail below with reference to the accompanying drawings.

### Example 1

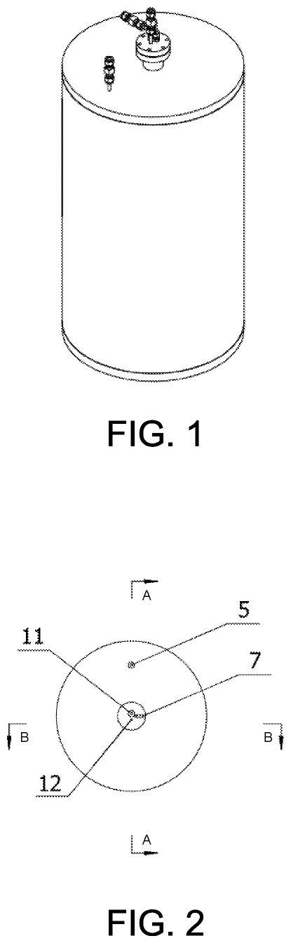

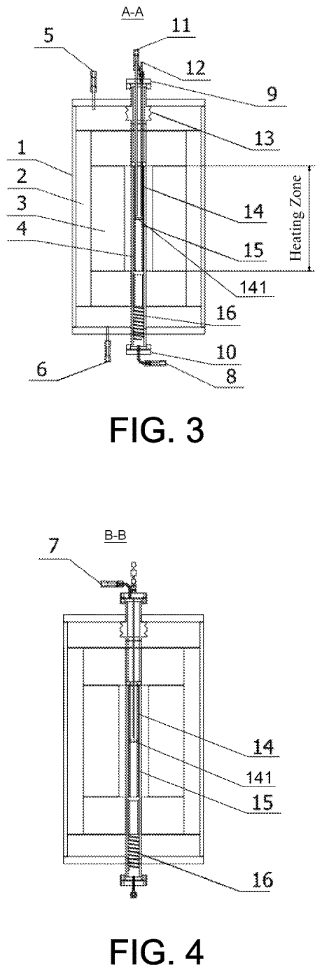

FIG. 1 is a schematic structural view of an integrated reactor provided in an example of the present application; FIG. 2 is a schematic top view of the integrated reactor provided in an example of the present application; FIG. 3 is a schematic A-A cross-sectional view of the integrated reactor provided in an example of the present application; FIG. 4 is a schematic B-B cross-sectional view of the integrated reactor provided in an example of the present application. Referring to FIGS. 1-4, an integrated reactor provided by the present application includes, from the outside to the inside in sequence: a pressure-resistant outer cylinder 1, a pressure balance chamber 2, a high-temperature heating furnace 3, and a microreactor 4.

The pressure-resistant outer cylinder 1 is made of stainless steel, has a cylindrical shape, is provided with a first pressurized gas outlet 5 at the top, and is provided with a first pressurized gas inlet 6 at the bottom.

The pressure balance chamber 2 is a chamber formed between an inner wall of the pressure-resistant outer cylinder 1 and outer walls of the high-temperature heating furnace 3 and the microreactor 4.

The high-temperature heating furnace 3 is arranged between the outer wall of the microreactor 4 and the pressure balance chamber 2.

The microreactor 4 is made of stainless steel and includes, from top to bottom in sequence, a first sealing flange 9, an expansion joint 13, a distribution-plate-equipped reaction tube 14, a reaction tube support column 15, a reaction tube support column lifting spring 16, and a second sealing flange 10. A second pressurized gas outlet 7, a temperature measuring thermocouple connection pipe 11, and a feed inlet connection pipe 12 are provided above the first sealing flange 9. The bottom openings of the temperature measuring thermocouple connection pipe 11 and the feed inlet connection pipe 12 are both positioned above a distributor plate 141. A second pressurized gas inlet 8 is provided below the second sealing flange 10. The distribution-plate-equipped reaction tube 14 is arranged in a constant temperature zone of the high-temperature heating furnace 3.

Further, each of the first pressurized gas outlet 5 and the second pressurized gas outlet 7 is connected to a safety relief valve.

Further, the microreactor 4 has a height of not more than 100 cm, and has an inner diameter of not more than 50 mm.

Further, the first pressurized gas inlet 6 is connected to a carrier gas to maintain a pressure inside the pressure balance chamber 2.

Further, the second pressurized gas inlet 8 is connected to a carrier gas to maintain a pressure inside the microreactor 4.

Further, the distribution-plate-equipped reaction tube 14 is made of a quartz material or a corundum material.

Further, a gas product generated by a reaction is discharged through the second pressurized gas outlet 7.

Process flow of the integrated reactor of the present application is as follows.

Firstly, fluidized particles (e.g., quartz sand) are preplaced into the distribution-plate-equipped reaction tube 14, and the microreactor 4 is assembled by means of sealing flanges; heating is performed to a preset temperature; then gas, such as nitrogen or air, is simultaneously introduced into the pressure balance chamber 2 and the microreactor 4 through the first pressurized gas inlet 6 and the second pressurized gas inlet 8 respectively according to set pressures to simultaneously pressurize the microreactor 4 and the pressure balance chamber 2, thereby reaching a high-temperature and high-pressure state; then, a sample is injected through the feed inlet connection pipe 12 into the distribution-plate-equipped reaction tube 14, and a gas product generated by a reaction is discharged through the second pressurized gas outlet 7.

The above specific embodiments further describe in detail the objectives, technical solutions, and beneficial effects of the present application. It should be understood that the above descriptions are merely specific embodiments of the present application and are not intended to limit the present application. Any modifications, equivalent substitutions, improvements, etc., made within the spirit and principles of the present application should be included within the protection scope of the present application.

What is claimed is:

1. A heating-and-pressurization integrated high-temperature and high-pressure microreactor, comprising a pressure-resistant outer cylinder, a pressure balance chamber, a high-temperature heating furnace, and a microreactor; wherein the pressure-resistant outer cylinder is provided with a first pressurized gas inlet and a first pressurized gas outlet; the pressure balance chamber, the high-temperature heating furnace, and the microreactor are comprised inside the pressure-resistant outer cylinder; the pressure balance chamber is a chamber formed between an inner wall of the pressure-resistant outer cylinder and outer walls of the high-temperature heating furnace and the microreactor, and the high-temperature heating furnace and the microreactor are disposed inside the chamber; the high-temperature heating furnace is a high-temperature micro heating furnace or a heating wire, disposed between the outer wall of the microreactor and the pressure balance chamber; the microreactor is arranged in the high-temperature heating furnace, the outer wall of the microreactor is connected to the pressure-resistant outer cylinder, both a top and a bottom of the microreactor are sealed by a first sealing flange and a second sealing flange, respectively; a feed inlet connection pipe, a temperature measuring thermocouple connection pipe, and a second pressurized gas outlet are provided above the first sealing flange on the top of the microreactor; a second pressurized gas inlet is provided on the second sealing flange at the bottom of the microreactor; a distribution-plate-equipped reaction tube, a reaction tube support column, and a reaction tube support column lifting spring are arranged inside the microreactor from top to bottom in sequence; the distribution-plate-equipped reaction tube is arranged in a constant temperature zone; an expansion joint is provided at an upper portion of the microreactor to prevent expansion of the microreactor during heating; and bottom openings of the feed inlet connection pipe and the temperature measuring thermocouple connection pipe are positioned above a distributor plate.

2. The heating-and-pressurization integrated high-temperature and high-pressure microreactor according to claim 1, wherein each of the first pressurized gas outlet and the second pressurized gas outlet is connected to a safety relief valve.

3. The heating-and-pressurization integrated high-temperature and high-pressure microreactor according to claim 1, wherein the microreactor has a height of not more than 100 cm, and has an inner diameter of not more than 50 mm.

4. The heating-and-pressurization integrated high-temperature and high-pressure microreactor according to claim 1, wherein the first pressurized gas inlet is connected to a carrier gas for maintaining a pressure inside the pressure balance chamber, and the second pressurized gas inlet is connected to a carrier gas for maintaining a pressure inside the microreactor.

5. The heating-and-pressurization integrated high-temperature and high-pressure microreactor according to claim 1, wherein the reaction tube is made of a material selected according to requirements of a reaction system, and the material is quartz tube or corundum.

6. The heating-and-pressurization integrated high-temperature and high-pressure microreactor according to claim 1, wherein a gas product generated by a reaction is discharged through the second pressurized gas outlet.

7. A operation method of a heating-and-pressurization integrated high-temperature and high-pressure microreactor, comprising the following operation flow: firstly, preplacing fluidized particles into a distribution-plate-equipped reaction tube, and assembling a microreactor by means of sealing flanges; performing heating to a preset temperature; then simultaneously introducing a gas, into a pressure balance chamber and the microreactor through a first pressurized gas inlet and a second pressurized gas inlet, respectively, according to set pressures to simultaneously pressurize the microreactor and the pressure balance chamber, thereby reaching a high-temperature and high-pressure state; and then injecting a sample through a feed inlet connection pipe into the distribution-plate-equipped reaction tube, wherein a gas product generated by a reaction is discharged through a second pressurized gas outlet.

8. The operation method according to claim 7, wherein the heating-and-pressurization integrated high-temperature and high-pressure microreactor comprises a pressure-resistant outer cylinder, the pressure balance chamber, a high-temperature heating furnace, and the microreactor; wherein the pressure-resistant outer cylinder is provided with the first pressurized gas inlet and a first pressurized gas outlet; the pressure balance chamber, the high-temperature heating furnace, and the microreactor are comprised inside the pressure-resistant outer cylinder; the pressure balance chamber is a chamber formed between an inner wall of the pressure-resistant outer cylinder and outer walls of the high-temperature heating furnace and the microreactor, and the high-temperature heating furnace and the microreactor are disposed inside the chamber; the high-temperature heating furnace is a high-temperature micro heating furnace or a heating wire, disposed between the outer wall of the microreactor and the pressure balance chamber; the microreactor is arranged in the high-temperature heating furnace, the outer wall of the microreactor is connected to the pressure-resistant outer cylinder, both a top and a bottom of the microreactor are sealed by a first sealing flange and a second sealing flange, respectively; the feed inlet connection pipe, a temperature measuring thermocouple connection pipe, and the second pressurized gas outlet are provided above the first sealing flange on the top of the microreactor; the second pressurized gas inlet is provided on the second sealing flange at the bottom of the microreactor; the distribution-plate-equipped reaction tube, a reaction tube support column, and a reaction tube support column lifting spring are arranged inside the microreactor from top to bottom in sequence; the distribution-plate-equipped reaction tube is arranged in a constant temperature zone; an expansion joint is provided at an upper portion of the microreactor to prevent expansion of the microreactor during heating; and bottom openings of the feed inlet connection pipe and the temperature measuring thermocouple connection pipe are positioned above a distributor plate.

9. The operation method according to claim 8, wherein each of the first pressurized gas outlet and the second pressurized gas outlet is connected to a safety relief valve.

10. The operation method according to claim 8, wherein the microreactor has a height of not more than 100 cm, and has an inner diameter of not more than 50 mm.

11. The operation method according to claim 8, wherein the first pressurized gas inlet is connected to a carrier gas for maintaining a pressure inside the pressure balance chamber, and the second pressurized gas inlet is connected to a carrier gas for maintaining a pressure inside the microreactor.

12. The operation method according to claim 8, wherein the reaction tube is made of a material selected according to requirements of a reaction system, and the material is quartz tube or corundum.

13. The operation method according to claim 8, wherein a gas product generated by a reaction is discharged through the second pressurized gas outlet.
